(19) United States
(12) Patent Application Publication
(10) Pub. No.: US 2021/0216938 A1
(43) Pub. Date: Jul. 15, 2021

(54) ENTERPRISE PLATFORM FOR ENHANCING OPERATIONAL PERFORMANCE

(71) Applicant: Johnson Controls Technology Company, Auburn Hills, MI (US)

(72) Inventors: Sikim Chakraborty, Kolkata (IN); Ovijeet Sircar, Kolkata (IN); Ankur Thareja, Alwar (IN); Sudhi R. Sinha, Milwaukee (US); Subrata Bhattacharya, Mumbai (IN); Shyam Sunder, Pune (IN); Nilankur Mazumdar, Pune (IN)

(73) Assignee: Johnson Controls Technology Company, Auburn Hills, MI (US)

(21) Appl. No.: 17/059,133

(22) PCT Filed: Jun. 1, 2018
(86) PCT No.: PCT/US2018/035603

§ 371 Date: Nov. 25, 2020

(51) Int. Cl. G06Q 10/06; G06Q 50/06; G06Q 10/00; G06Q 30/00; G06Q 30/02; G06K 9/00; G06N 20/00

(52) U.S. Cl. CPC G06Q 10/06393; G06Q 50/06; G06Q 10/30; G06Q 30/018; G06Q 10/20; G06N 20/00; G06Q 30/0242; G06Q 10/063118; G06Q 30/0269; G06Q 30/0281; G06K 9/00288; G06Q 30/0201

(57) ABSTRACT

A building management enterprise system includes a display device, one or more processors, and one or more computer-readable storage media communicably coupled to the one or more processors and having instructions stored thereon that cause the one or more processors to: identify one or more factors for evaluating economic effectiveness of an enterprise having a plurality of physical nodes; receive data associated with each of the factors from a plurality of data sources for each of the nodes, the plurality of data sources including at least one sensor located in each of the nodes; determine a benchmark value for each of the factors; compare the data received from the plurality of data sources with the benchmark value for each of the factors; calculate an effectiveness score for each of the factors based on the compare; and control the display device to display performance indicators associated with the effectiveness scores.

### BACKGROUND

The present disclosure relates generally to the field of an enterprise platform for analyzing data from a building management system (BMS) and various devices to generate actionable insights in relation to the performance of a retail enterprise. A BMS is, in general, a system of devices configured to control, monitor, and manage equipment in or around a building or building area. A BMS can include, for example, a HVAC (heating, ventilation, and air conditioning) system, a security system, a lighting system, a fire alerting system, and/or any other system that is capable of managing building functions or devices.

With the advent of digital marketplaces and changing customer preferences, brick and mortar nodes (or stores) of retail enterprises are facing a variety of challenges. In response to these challenges, retail enterprises employ a variety of strategies in an effort to make each node more effective. For example, some of these strategies include operation optimization, customer experience enhancement, competitive pricing arrangements, product planning, product placement, and the like, that result in varying degrees of efficacy.

To implement these strategies, current solutions utilize data analytics to analyze data from various data sources at each node. These current data analytics solutions use data types in isolation to deliver a particular value to the retail enterprise in a generic index. However, it may be important for the retail enterprise to understand the granular details of all factors (e.g., key drivers or key performance indicators) that affect the performance of each node, as well as understand the impact of all the data to the vision (preferences or goals) of the retail enterprise.

The above information disclosed in this background section is for enhancement of understanding of the background of the invention, and therefore, it may contain information that does not constitute prior art.

### SUMMARY

One implementation of the present disclosure is a building management enterprise system including a display device, one or more processors, and one or more computer-readable storage media communicably coupled to the one or more processors. The one or more computer-readable storage media have instructions stored thereon that, when executed by the one or more processors, cause the one or more processors to identify one or more factors for evaluating economic effectiveness of an enterprise comprising a plurality of physical nodes, receive data associated with each of the factors from a plurality of data sources for each of the nodes, the plurality of data sources including at least one sensor located in each of the nodes, determine a benchmark value for each of the factors, compare the data received from the plurality of data sources with the benchmark value for each of the factors, calculate an effectiveness score for each of the factors based on the compare, and control the display device to display one or more performance indicators associated with the effectiveness score for each of the nodes.

In some embodiments, the one or more factors may include revenue, energy efficiency, equipment efficiency, waste management, and regulatory compliance.

In some embodiments, the plurality of data sources may further include at least one sales data repository, enterprise resource planning repository, equipment maintenance repository or regulatory compliance repository.

In some embodiments, the instructions may further cause the one or more processors to calculate a weightage for each of the one or more factors based on one or more priorities of the enterprise.

In some embodiments, each of the one or more factors may contribute to the effectiveness score based on the weightage for each of the one or more factors.

In some embodiments, each of the one or more factors may include a plurality of sub-factors.

In some embodiments, the instructions may further cause the one or more processors to determine a maximum score for each of the sub-factors, wherein a total sum of the maximum scores for the sub-factors correspond to the weightage of the factor.

In some embodiments, the instructions may further cause the one or more processors to identify desired data for evaluating each of the one or more factors, compare the received data with the desired data to determine missing data, and control the display device to display a recommendation to configure one or more additional data sources to generate at least some of the missing data.

In some embodiments, the performance indicators may be presented on an interactive dashboard, and the instructions may further cause the one or more processors to receive a selection of a node from among the plurality of nodes, and control the display device to display a detailed overview of the performance indicators for the selected nodes.

In some embodiments, the instructions may further cause the one or more processors to receive a selection of another node for comparing the performance indicators of the selected nodes, and control the display device to display a comparison of the performance indicators for the selected nodes.

Another implementation of the present disclosure is a building management enterprise system including one or more camera devices, one or more processors, and one or more computer-readable storage media communicably coupled to the one or more processors. The one or more computer-readable storage media have instructions stored thereon that, when executed by the one or more processors, cause the one or more processors to receive facial data from the one or more camera devices, classify the facial data based on an emotion or demographic associated with an image in the facial data, analyze the classified facial data to identify one or more performance indicators for a physical node of an enterprise, and control the display device to display the one or more performance indicators for the node.

In some embodiments, the one or more performance indicators may include at least one of customer satisfaction, foot traffic performance, staffing performance, advertisement effectiveness, product placement effectiveness, or product pricing performance.

In some embodiments, a first camera device from among the one or more camera devices may be arranged to capture entering customers when entering the node, and a second camera device from among the one or more camera devices is arranged to capture leaving customers when leaving the node.

In some embodiments, the instructions may further cause the one or more processors to receive facial data from the first camera device corresponding to the entering customers, count a number of customers from among the entering customers exhibiting a first emotion from the facial data received from the first camera device, receive facial data from the second camera device corresponding to the leaving customers, count a number of customers from among the leaving customers exhibiting the first emotion from the facial data received from the second camera, determine a change of emotions between the number of entering customers exhibiting the first emotion and the number of leaving customers exhibiting the first emotion, and analyze the one or more performance indicators based on the change of emotions.

In some embodiments, the instructions may further cause the one or more processors to receive sales data from a data source associated with the node, associate the sales data with the change of emotions, and analyze the one or more performance indicators based on the sales data and the change of emotions.

In some embodiments, the instructions may further cause the one or more processors to calculate a peak shopping time from the facial data, generate a recommendation for staffing the node based on the peak shopping time, and control the display device to display the recommendation.

In some embodiments, a camera device from among the one or more camera devices may be arranged to capture a customer's face while viewing a product, and the instructions may further cause the one or more processors to determine a change in emotion of the customer while viewing the product based on the facial data, and analyze the one or more performance indicators based on the change in emotion.

In some embodiments, a camera device from among the one or more camera devices may be arranged to capture viewers of an advertisement board.

In some embodiments, the instructions may further cause the one or more processors to track the demographics of the viewers viewing the advertisement board based on the facial data over a period of time, generate a report of the demographics for the period of time, and control the display device to display the report.

In some embodiments, the advertisement board may be a digital advertisement board, and the instructions may further cause the one or more processors to determine a demographic of a current viewer from among the viewers of the advertisement board from the facial data, select content to be displayed on the digital advertisement board based on the demographic of the current viewer, and control the digital advertisement board to display the content.

### BRIEF DESCRIPTION OF THE DRAWINGS

The above and other aspects and features of the present disclosure will become more apparent to those skilled in the art from the following detailed description of the example embodiments with reference to the accompanying drawings, in which:

FIG. 1 is a block diagram of an enterprise system according to some embodiments;

FIG. 2 is an exemplary building management system according to an exemplary embodiment;

FIG. 3 is a more detailed block diagram of an enterprise system according to some exemplary embodiments;

FIG. 4 is a block diagram illustrating another enterprise platform according to some exemplary embodiments;

FIG. 5 is a block diagram illustrating a convolutional neural network system operation for the enterprise platform illustrated in FIG. 4 according to some exemplary embodiments;

FIG. 6 is a flow diagram for an effectiveness score operation for the enterprise platform illustrated in FIG. 4 according to some exemplary embodiments; and

FIG. 7 is a flow diagram for generating actionable insights based on facial data for the enterprise platform illustrated in FIG. 4, according to some exemplary embodiment.

### DETAILED DESCRIPTION

Hereinafter, example embodiments will be described in more detail with reference to the accompanying drawings.

Overview

According to various embodiments, an enterprise system is provided that amalgamates data from a variety of data sources to calculate an effectiveness score for the performance of a retail enterprise. The sources of data may include, for example, building subsystems, building equipment, sensors related to building equipment, enterprise resource planning (ERP) systems, one or more camera devices located in a building or node (e.g., a brick and mortar store) of the retail enterprise, 3^{rd} party data (e.g., weather data, social media data, news data, and/or the like), customer data (e.g., billing data and loyalty program data), sales data, and/or any other suitable data sources. The enterprise system correlates the data with various factors (also referred to as key drivers or key performance indicators) used to calculate the effectiveness score, and manages tradeoffs between the factors according to the priorities or goals of the retail enterprise. The enterprise system analyzes the data and provides actionable insights to the retail enterprise for enhancing the operational efficiency. For example, the enterprise system may provide a graphical user-interface (GUI) or dashboard to present a scorecard corresponding to the effectiveness score with key performance indicators, so that a retail enterprise can determine how to improve the operational efficiency for each node.

According to various embodiments, the enterprise system can analyze facial data of customers of each node of the retail enterprise. In some embodiments, the enterprise system receives the facial data from one or more cameras located at various locations, and performs facial recognition on the facial data to determine emotions, demographics, preferences, and the like, of the customers corresponding to the facial data. In some embodiments, the camera devices can be arranged and configured to capture the facial data as customers enter a node, leave a node, purchase products or services, view products, view advertisements boards, and/or the like. In some embodiments, the enterprise system can correlate the facial data with other data, such as sales data, to understand customer insights based on the correlated data.

In some embodiments, the enterprise system may generate recommendations for the retail enterprise to help improve the effectiveness score based on the analyzed data. For example, the enterprise system may determine peak shopping times and/or down shopping times from the analyzed data, and may recommend staffing adjustments based on the peak/down shopping times. In some embodiments, the enterprise system may determine key demographics of the main customer base of a node of the retail enterprise, and may recommend product planning, price adjustments, advertising adjustments, and/or the like, based on the key demographics. In some embodiments, the enterprise system may dynamically select content for digital advertisement boards in real-time or near real-time based on the demographics of a viewer viewing the digital advertisement board.

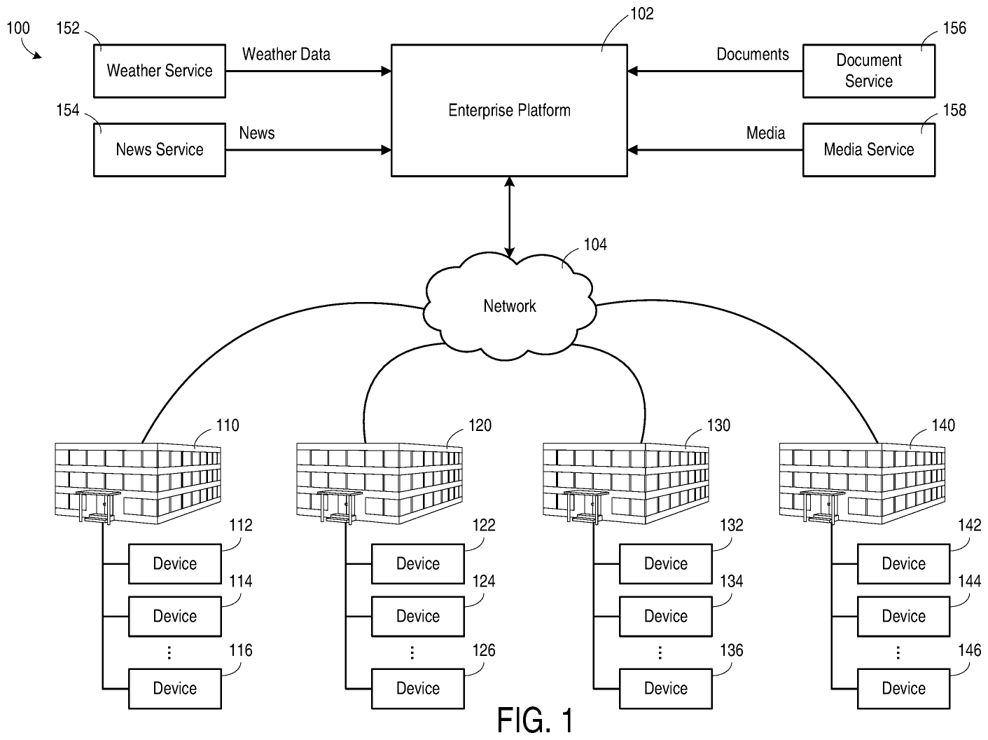

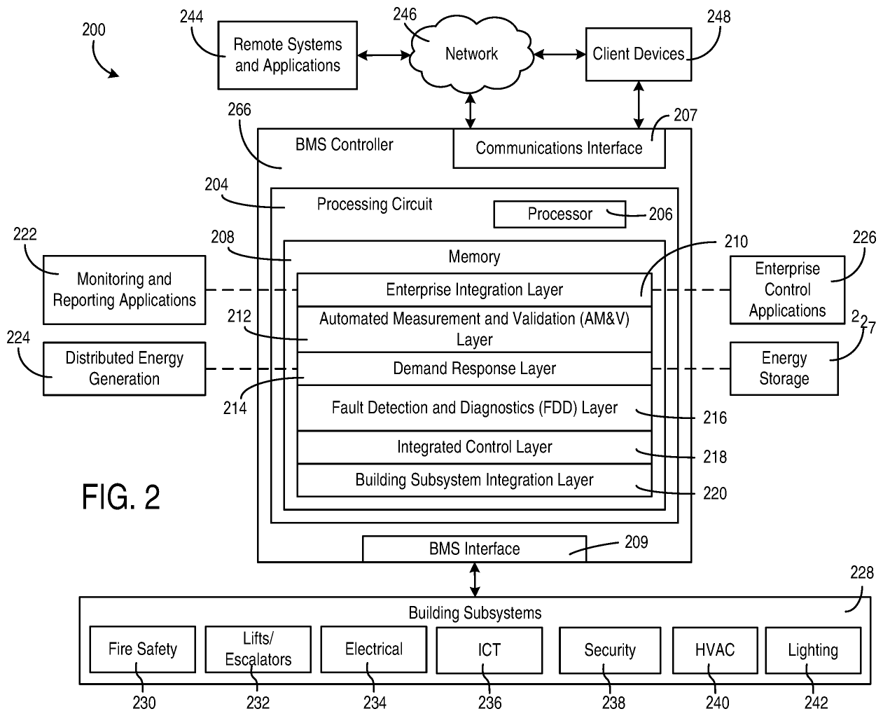

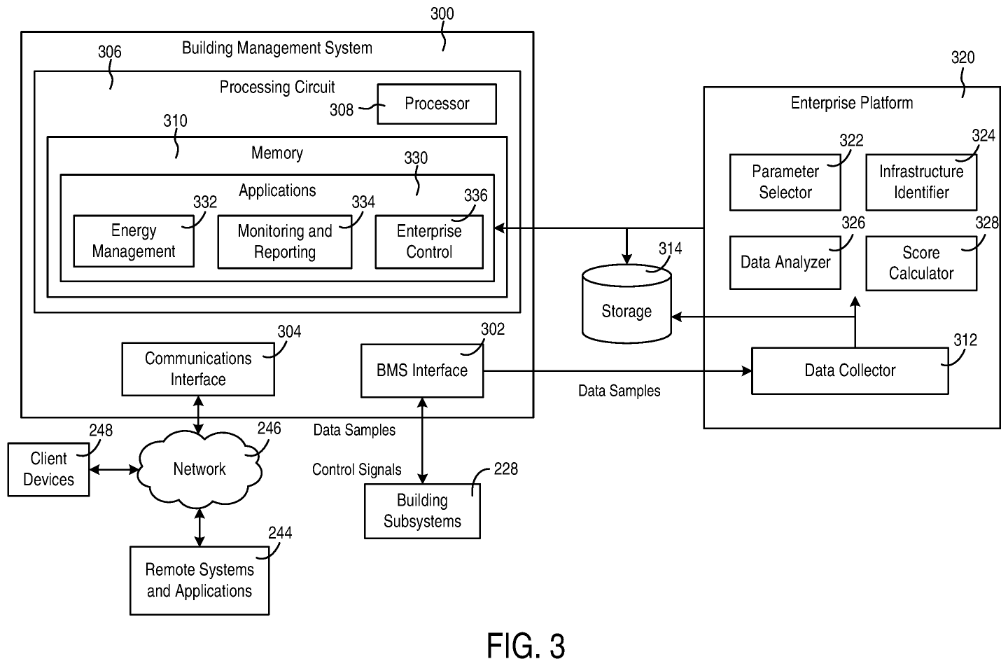

Referring to FIG. 1, a block diagram of an enterprise system 100 is shown, according to some embodiments. Enterprise system 100 is shown to include an enterprise platform 102. Enterprise platform 102 can be configured to collect data from a variety of different data sources. For example, enterprise platform 102 is shown collecting data from buildings 110, 120, 130, and 140. Each of the buildings 110, 120, 130, and 140 may include a BMS, for example, such as any of the BMSs described with reference to FIGS. 2 and 3. Each of the buildings 110, 120, 130, and 140 may be any suitable type of building, for example, such as a shopping mall, grocery store, office building, school, hospital, factory, and/or the like. In another example, each of the buildings 110, 120, 130, and 140 may represent a brick and mortar store (or node) of a retail enterprise. However the present disclosure is not limited to the number or types of buildings or nodes 110, 120, 130, and 140 shown in FIG. 1. For example, in some embodiments, the buildings may be of the same type, or at least one of the buildings may represent an online retail store of the retail enterprise.

Enterprise platform 102 can be configured to collect data from a variety of devices 112-116-126, 132-136, and 142-146, either directly (e.g., directly via network 104) or indirectly (e.g., via the BMS or applications for the buildings 110, 120, 130, 140). In some embodiments, devices 112-116, 122-126, 132-136, and 142-146 may include building equipment, metering devices, camera devices, mini computers, sensors, internet of things (IoT) devices, and/or any suitable devices. Camera devices may be closed-circuit television (CCTV) cameras or internet protocol (IP) cameras. IoT devices may include any of a variety of physical devices, sensors, actuators, electronics, vehicles, home appliances, and/or other devices having network connectivity which enable IoT devices to communicate with enterprise platform 102 (or the BMS). For example, IoT devices can include networked cameras, networked sensors, wireless sensors, wearable sensors, environmental sensors, RFID gateways and readers, IoT gateway devices, robots and other robotic devices, GPS devices, smart watches, smart phones, tablets, virtual/augmented reality devices, and/or other networked or networkable devices. However, the present disclosure is not limited thereto, and it should be understood that, in various embodiments, the devices referenced in the present disclosure could be any type of suitable devices capable of communicating data over an electronic network.

In some embodiments, enterprise platform 102 can collect data from a variety of external systems or services. For example, enterprise platform 102 is shown receiving weather data from a weather service 152, news data from a news service 154, documents and other document-related data from a document service 156, and media (e.g., video, images, audio, social media, etc.) and other data (e.g., data feeds) from a media service 158. In some embodiments, enterprise platform 102 generates data internally. For example, enterprise platform 102 may include a web advertising system, a website traffic monitoring system, a web sales system, or other types of platform services that generate data. The data generated by enterprise platform 102 can be collected, stored, and processed along with the data received from other data sources. Enterprise platform 102 can collect data directly from external systems or devices or via a network 104 (e.g., a WAN, the Internet, a cellular network, smart phones, data available from the network 104, etc.).

In various embodiments, enterprise platform 102 collects and analyzes data from a variety of data sources to calculate an effectiveness score. The effectiveness score is used to provide actionable insights to the retail enterprise for enhancing operational efficiency of one or more nodes (e.g., brick and mortar retail stores) of the retail enterprise. In some embodiments, weightage is applied to various factors depending on the retail enterprise's priorities or goals, so that those factors are given more weight in the effectiveness score calculation. In some embodiments, the effectiveness score is presented to the user on a graphical user interface (GUI) or dashboard, which allows the user to select performance indicators for each node of the retail enterprise. The user can view the performance indicators for the retail enterprise as a whole or for each node, and can compare performance indicators between various nodes to determine where the operational efficiency can be enhanced. Several features of enterprise platform 102 are described in more detail below.

### Building Management System

Referring now to FIG. 2, an example building management system (BMS) is shown, according to an exemplary embodiment. Each of the buildings or nodes 110, 120, 130, and 140 may be served by one or more BMS(s). The nodes 110, 120, 130, and 140 are entire buildings, portions of buildings, a building area, a store, a room, or a group of rooms. A BMS is, in general, a system of devices configured to control, monitor, and manage equipment in or around a building, building area, or node. A BMS can include, for example, a HVAC system, a security system, a lighting system, a fire alerting system, and any other system that is capable of managing building functions or devices, or any combination thereof. BMS 200 can be implemented in any of the buildings 110, 120, 130, and 140 to automatically monitor and control various building functions. BMS 200 is shown to include BMS controller 266 and a plurality of building subsystems 228. Building subsystems 228 may include a fire safety subsystem 230, a lift/escalators subsystem 232, a building electrical subsystem 234, an information communication technology (ICT) subsystem 236, a security subsystem 238, a HVAC subsystem 240, a lighting subsystem 242, and/or the like. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control the equipment, devices, and systems in the building.

Each of building subsystems 228 can include any number of devices, controllers, and connections for completing its individual functions and control activities. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within the building. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BMS controller 266 is shown to include a communications interface 207 and a BMS interface 209. Interface 207 can facilitate communications between BMS controller 266 and external applications (e.g., monitoring and reporting applications 222, enterprise control applications 226, remote systems and applications 244, applications residing on client devices 248, etc.) for allowing user control, monitoring, and adjustment to BMS controller 266 and/or subsystems 228. Interface 207 can also facilitate communications between BMS controller 266 and client devices 248. BMS interface 209 can facilitate communications between BMS controller 266 and building subsystems 228 (e.g., HVAC, lighting security, lifts, power distribution, business, etc).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In one embodiment, communications interface 207 is a power line communications interface and BMS interface 209 is an Ethernet interface. In other embodiments, both communications interface 207 and BMS interface 209 are Ethernet interfaces or are the same Ethernet interface.

Still referring to FIG. 2, BMS controller 266 is shown to include a processing circuit 204 including processor 206 and memory 208. Processing circuit 204 can be communicably connected to BMS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 204 and includes computer code for executing (e.g., by processing circuit 204 and/or processor 206) one or more processes described herein.

In some embodiments, BMS controller 266 is implemented within a single computer (e.g., one server, one housing, etc.). In various other embodiments BMS controller 266 can be distributed across multiple servers or computers (e.g., that can exist in distributed locations). Further, while FIG. 2 shows applications 222 and 226 as existing outside of BMS controller 266, in some embodiments, applications 222 and 226 can be hosted within BMS controller 266 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 can be configured to receive inputs from building subsystems 228 and other data sources, determine optimal control actions for building subsystems 228 based on the inputs, generate control signals based on the optimal control actions, and provide the generated control signals to building subsystems 228. The following paragraphs describe some of the general functions performed by each of layers 210-220 in BMS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BMS controller 266. In yet other embodiments, enterprise control applications 226 can work with layers 210-220 to optimize building performance (e.g., efficiency, energy use, comfort, or safety) based on inputs received at interface 207 and/or BMS interface 209.

Building subsystem integration layer 220 can be configured to manage communications between BMS controller 266 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translate communications (e.g., sensor data, input signals, output signals, etc.) across a plurality of multi-vendor/multi-protocol systems.

Demand response layer 214 can be configured to optimize resource usage (e.g., electricity use, natural gas use, water use, etc.) and/or the monetary cost of such resource usage in response to satisfy the demand of the building. The optimization can be based on time-of-use prices, curtailment signals, energy availability, or other data received from utility providers, distributed energy generation systems 224, from energy storage 227, or from other sources. Demand response layer 214 can receive inputs from other layers of BMS controller 266 (e.g., building subsystem integration layer 220, integrated control layer 218, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc).

Demand response layer 214 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc) into and out of energy storage devices (e.g., thermal storage tanks, battery banks, etc.), and when to dispatch on-site generation of energy (e.g., via fuel cells, a motor generator set, etc.

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from a plurality of building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration may advantageously reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BMS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BMS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alert a user to repair the fault before it becomes more severe.

### Enterprise System

Referring now to FIG. 3, a block diagram of an enterprise system is shown in more detail, according to some embodiments. The enterprise system includes a building management system (BMS) 300 and an enterprise platform 320. BMS 300 is configured to collect data samples from building subsystems 228 and provide the data samples to enterprise platform 320. While FIG. 3 shows one BMS 300 connected to enterprise platform 320, the present disclosure is not limited thereto. For example, as shown in FIG. 1, enterprise platform 320 can be connected to one or more buildings or nodes 110, 120, 130, 140, each having its own BMS or multiple BMS's, or BMS 300 can be connected to one or more buildings or nodes 110, 120, 130, 140.

It should be noted that, in some embodiments, the components of BMS 300 and/or enterprise platform 320 is integrated within a single device (e.g., a supervisory controller, a BMS controller, etc.) or distributed across multiple separate systems or devices. In other embodiments, some or all of the components of BMS 300 and/or enterprise platform 320 is implemented as part of a cloud-based computing system configured to receive and process data from one or more building management systems. In other embodiments, some or all of the components of BMS 300 and/or enterprise platform 320 are components of a subsystem level controller (e.g., a HVAC controller), a subplant controller, a device controller (e.g., AHU controller 330, a chiller controller, etc.), a field controller, a computer workstation, a client device, or any other system or device that receives and processes data from building systems and equipment.

In some embodiments, BMS 300 is the same as or similar to BMS 200, as described with reference to FIG. 2, or includes many of the same components as BMS 200. For example, in some embodiments, BMS 300 includes a BMS interface 302 and a communications interface 304. In some embodiments, interfaces 302-304 include wired or wireless communications interfaces (e.g., jacks, antennas, transmitters, receivers, transceivers, wire terminals, etc.) for conducting data communications with building subsystems 228 or other external systems or devices. In some embodiments, communications conducted via interfaces 302-304 are direct (e.g., local wired or wireless communications) or via a communications network 246 (e.g., a WAN, the Internet, a cellular network, etc.).

Communications interface 304 facilitates communications between BMS 300 and external applications (e.g., remote systems and applications 244) for allowing user control, monitoring, and adjustment to BMS 300. Communications interface 304 also facilitates communications between BMS 300 and client devices 248. BMS interface 302 facilitates communications between BMS 300 and building subsystems 228. BMS 300 is configured to communicate with building subsystems 228 using any of a variety of building automation systems protocols (e.g., BACnet, Modbus, ADX, etc.). In some embodiments, BMS 300 receives data samples from building subsystems 228 and provides control signals to building subsystems 228 via BMS interface 302.

In some embodiments, building subsystems 228 include fire safety subsystem 230, lift/escalators subsystem 232, building electrical subsystem 234, information communication technology (ICT) subsystem 236, security subsystem 238, HVAC subsystem 240, lighting subsystem 242, and/or the like, as described with reference to FIG. 2. In various embodiments, building subsystems 228 include fewer, additional, or alternative subsystems. For example, in some embodiments, building subsystems 228 also or alternatively include a refrigeration subsystem, an advertising or signage subsystem; a cooking subsystem, a vending subsystem, a printer or copy service subsystem, or any other type of building subsystem that uses controllable equipment and/or sensors to monitor or control equipment, devices, and systems in the building. In some embodiments, building subsystems 228 include a waterside system and/or airside system. Each of building subsystems 228 can include any number of devices, controllers, and connections for completing its individual functions and control activities. In various embodiments, building subsystems 228 include building equipment (e.g., sensors, air handling units, chillers, pumps, valves, etc.) configured to monitor and control a building condition such as temperature, humidity, airflow, etc.

BMS 300 includes a processing circuit 306 including a processor 308 and memory 310, in some embodiments. Enterprise platform 320 also includes one or more processing circuits including one or more processors and memory, in some embodiments. In various embodiments, each of the processors are a general purpose or specific purpose processor, an application specific integrated circuit (ASIC), one or more field programmable gate arrays (FPGAs), a group of processing components, or other suitable processing components. Each of the processors is configured to execute computer code or instructions stored in memory or received from other computer readable media (e.g., CDROM, network storage, a remote server, etc.).

In some embodiments, memory includes one or more devices (e.g., memory units, memory devices, storage devices, etc.) for storing data and/or computer code for completing and/or facilitating the various processes described in the present disclosure. In various embodiments, memory includes random access memory (RAM), read-only memory (ROM), hard drive storage, temporary storage, non-volatile memory, flash memory, optical memory, or any other suitable memory for storing software objects and/or computer instructions. In various embodiments, memory includes database components, object code components, script components, or any other type of information structure for supporting the various activities and information structures described in the present disclosure. In some embodiments, memory is communicably connected to the processors via the processing circuits, and includes computer code for executing (e.g., by processor 308) one or more processes described herein.

Still referring to FIG. 3, enterprise platform 320 includes a data collector 312. Data collector 312 receives data samples from building subsystems 228 via BMS interface 302. However, the present disclosure is not limited thereto, and in some embodiments, the data collector 312 receives the data samples directly from the building subsystems 228 (e.g., via network 246 or via any suitable method). In some embodiments, the data samples include data or data values for various data points. The data values are collected, measured, or calculated values, depending on the type of data point. For example, a data point received from a temperature sensor can include a measured data value indicating a temperature measured by the temperature sensor. A data point received from a chiller controller can include a calculated data value indicating a calculated efficiency of the chiller. In some embodiments, data collector 312 receives data samples from multiple different devices (e.g., building equipment, camera devices, IoT devices, sensors, etc.) within building subsystems 228.

In some embodiments, the data samples include one or more attributes that describe or characterize the corresponding data or data points. For example, the data samples include a name attribute defining a point name or ID (e.g., “B1F4R2.T-Z”), a device attribute indicating a type of device from which the data samples is received (e.g., camera device, temperature sensor, motion sensor, occupancy sensor, humidity sensor, chiller, etc.), a unit attribute defining a unit of measure associated with the data value (e.g., ° F., ° C., kPA, etc.), if applicable, and/or any other attribute that describes the corresponding data point or provides contextual information regarding the data point. The types of attributes included in each data point can depend on the communications protocol used to send the data samples to BMS 300 and/or entity platform 320. For example, data samples received via the ADX protocol or BACnet protocol can include a variety of descriptive attributes along with the data value, whereas data samples received via the Modbus protocol can include a lesser number of attributes (e.g., only the data value without any corresponding attributes).

In some embodiments, each data sample is received with a timestamp indicating a time at which the corresponding data value was collected, measured, or calculated. In other embodiments, data collector 312 adds timestamps to the data samples based on the times at which the data samples are received. In some embodiments, data collector 312 generates raw timeseries data for each of the data points for which data samples are received. Each timeseries includes a series of data values for the same data point and a timestamp for each of the data values. For example, a time series for a data point provided by a camera device can include a series of image frames and the corresponding times at which the image frames were captured by the camera device. A timeseries for a data point provided by a temperature sensor can include a series of temperature values measured by the temperature sensor and the corresponding times at which the temperature values were measured. An example of a timeseries which is generated by data collector 312 is as follows:
[<key,timestamp₁,value₁>,<key,timestamp₂,value₂>, <key,timestamp₃,value₃>]
   where key is an identifier of the source of the raw data samples (e.g., timeseries ID, sensor ID, device ID, etc.), timestamp₁ identifies the time at which the ith sample was collected, and valueᵢ indicates the value of the ith sample.

In some embodiments, data collector 312 adds timestamps to the data samples or modifies existing timestamps, such that each data sample includes a local timestamp. Each local timestamp indicates the local time at which the corresponding data sample was measured or collected and can include an offset relative to universal time. The local timestamp indicates the local time at the location the data point was measured or collected at the time of measurement or collection. The offset indicates the difference between the local time and a universal time (e.g., the time at the international date line). For example, a data sample collected in a time zone that is six hours behind universal time can include a local timestamp (e.g., Timestamp=2016-03-18T14:10:02) and an offset indicating that the local timestamp is six hours behind universal time (e.g., Offset=−6:00). The offset can be adjusted (e.g., +1:00 or −1:00) depending on whether the time zone is in daylight savings time when the data sample is measured or collected.

The combination of the local timestamp and the offset provides a unique timestamp across daylight saving time boundaries. This allows an application using the timeseries data to display the timeseries data in local time without first converting from universal time. The combination of the local timestamp and the offset also provides enough information to convert the local timestamp to universal time without needing to look up a schedule of when daylight savings time occurs. For example, the offset can be subtracted from the local timestamp to generate a universal time value that corresponds to the local timestamp without referencing an external database and without requiring any other information.

In some embodiments, data collector 312 organizes the data samples (e.g., raw timeseries data). Data collector 312 identifies a system or device associated with each of the data points. For example, data collector 312 associates a data point with a camera device, a temperature sensor, an air handler, a chiller, or any other type of system or device.

In some embodiments, a data entity may be created for the data point, in which case, the data collector 312 associates the data point with the data entity. In various embodiments, data collector uses the name of the data point, a range of values of the data point, statistical characteristics of the data point, or other attributes of the data point to identify a particular system or device associated with the data point. Data collector 312 determines how that system or device relates to the other systems or devices in the building site from entity data. For example, data collector 312 can determine that the identified system or device is part of a larger system (e.g., a HVAC system) or serves a particular space (e.g., a particular building, a room or zone of the building, etc.) from entity data. In some embodiments, data collector 312 uses or retrieves an entity graph when organizing the timeseries data.

In some embodiments, data collector 312 provides the data samples (e.g., raw timeseries data) to the components and services of enterprise platform 320 and/or store the data samples in storage 314. Storage 314 can be internal storage or external storage. For example, storage 314 can be internal storage with relation to enterprise platform 320 and/or BMS 300, and/or can include a remote database, cloud-based data hosting, or other remote data storage. In various embodiments, storage 314 is configured to store the data samples obtained by data collector 312, data generated by enterprise platform 320, and/or directed acyclic graphs (DAGs) used by enterprise platform 320 to process the data samples.

Still referring to FIG. 3, enterprise platform 320 receives the data samples from the data collector 312 and/or retrieves the data samples from storage 314, in some embodiments. Enterprise platform 320 includes a variety of services configured to analyze and process the data samples. For example, in some embodiments, enterprise platform 320 includes a parameter selector 322, infrastructure identifier 324, a data analyzer 326, and a score calculator 328. The parameter selector 322 identifies the factors that are important to the retail enterprise based on the priorities and goals of the retail enterprise. For example, the main driver of most retail enterprises is economic benefits, and some factors that affect economic benefits may include stakeholder experience, risk management, regulatory compliance, customer insights, operational performance, environmental performance, safety and security, and/or the like. However, one retail enterprise may place a higher emphasis on sales numbers, while another retail enterprise may place a higher emphasis on regulatory compliance to reduce costs associated with penalties or the like. Accordingly, the parameter selector 322 allows a retail enterprise to customize the effectiveness score by identifying the important factors for the effectiveness score based on the priorities and goals of the retail enterprise.

The infrastructure identifier 322 analyzes the current infrastructure (hardware and software) of the nodes of the retail enterprise, and identifies various data sources that generate and transmit data from the nodes. Infrastructure identifier 322 determines whether the various data sources generate sufficient data for each of the selected factors in order to calculate the effectiveness score. If infrastructure identifier 322 determines that some desired data is not received, infrastructure identifier 322 requests (e.g., provide instructions or suggestions) that additional data sources be added or configured to generate the desired data. For example, in order to generate an effectiveness score based on the customer insight factor, data may be desired from a plurality of camera devices to capture customers' facial expressions as they enter and leave the store. In this example, infrastructure identifier 322 determines that data is received from a camera device that captures customers' facial data as they enter the store, but no data is received from a camera device that captures customers' facial data as they leave the store. In this case, infrastructure identifier 322 can request that a camera device be added, arranged, or configured to capture and transmit customers' facial data as they leave the store.

The data analyzer 320 analyzes the received data from the various data sources and organizes the data for calculating the effectiveness score. In some embodiments, the data analyzer 320 cleanses the data to eliminate or reduce unnecessary data, and identifies relationships between different data or data sources. In some embodiments, the relationships between the different data or data sources are used by the enterprise platform 320 to determine tradeoffs between the factors to derive actionable insights based on the data. For example, the data analyzer 320 may identify a link between HVAC usage and the arrangement of employees stationed around the store. In another example, the data analyzer 320 may identify that sales performance of a node or customer satisfaction is directly linked to the customers' facial expressions or emotions when entering and leaving the node.

In various embodiments, the data analyzer 320 segregates the data corresponding to each of the factors. For example, some factors that may be important for a particular retail enterprise include building energy performance, equipment performance, occupant comfort, operation and maintenance, water usage, renewable energy, waste management, compliance, and space utilization. In this example, the data analyzer 320 receives data from various sources and segregates the data for each of the relevant categories or factors as shown in Table 1:

| Categories | Data Source | Data Set | Raw Data Format |
|---|---|---|---|
| Energy | Eleatic/Power meter | kWh | Modbus/BACnet/XML/CSV/APIs |
| Consumption | (HVACR, Lighting, | kW | |
| (for calculating | Plug loads) | pf | |
| building energy | | KVAr | |
| performance, water | | Volt | |
| usage, and | | Ampere | |
| renewable energy) | Water meter | Gallons | |
| | | Liters | |
| | BTU meter | Btu | |
| Equipment | BMS | Run hours | BACnet/OPC/CSV/SQL |
| Categories | Data Source | Data Set | Raw Data Format |
| Efficiency | Network Controller | Down time | |
| (for calculating | Field Controller | Internal parameters | |
| equipment | | | |
| performance) | | | |
| Occupant Comfort | BMS | Number of overrides | BACnet/OPC/CSV/SQL |
| (for calculating | Network Controller | of zone temperature | |
| occupant comfort) | Field Controller | Average zone | |
| | Sensors | temperature | |
| | | Average deviation | |
| | | from temperature set- | |
| | | point | |
| | | CO₂ level (ppm) | |
| Operation & | BMS | Number of | BACnet/OPC/CSV/SQL |
| Maintenance | Safety & Security | alarms/faults/work | |
| (for calculating | system | orders from different | |
| operation and | | categories (HVACR, | |
| maintenance) | | Lighting, Energy, | |
| | | Access, Fire) | |
| | | Number of Faults | |
| | | Time duration of | |
| | | Faults | |
| Compliance | BMS | Zone temperature | BACnet/OPC/CSV/SQL |
| (for calculating | Safety & Security | CO₂ level | |
| compliance) | system | Fire Alarm count | |
| Space Utilization | BMS | Number of Employees | BACnet/OPC/CSV/SQL |
| (for calculating | Access, Security, Time, & | present at any given | |
| space utilization) | Attendance system | time | |

In some embodiments, the data analyzer 326 analyzes the received data, and baselines the data for each of the relevant factors in the effectiveness score calculation to determine a deviation (or change) between the data and the baseline. For example, for the building energy performance factor, the data analyzer 320 may compare a present energy usage index (EUI) with a baseline value that is normalized with weather data to determine if there is a deviation therebetween. For the equipment performance factor, the data analyzer 320 may compare the energy used for each equipment with the baseline design specification for the equipment considering the age, equipment type, run time, downtime, and the like, and may determine if there is a deviation in key parameter values. For the occupant comfort factor, the data analyzer 320 may calculate an occupant comfort level based on various parameters, for example, such as IAQ (temperature, humidity, CO2, ventilation rate, and the like), visual comfort (e.g., from camera device data), temperature set-point deviation, number of zone temperature overrides, and the like. For the operation and maintenance factor, the data analyzer 320 may analyze various parameters such as equipment run times, auto/manual control modes, preventative maintenance records, alarms and faults duration, work order analysis, and time duration for resolving the alarms, faults, work orders, and the like. For the water usage factor, the data analyzer 320 may compare the present water consumption with a baseline value to determine if there is a deviation therebetween. For the renewable energy factor, the data analyzer 320 may analyze the energy generated, used, and/or exported to the grid. For the waste management factor, the data analyzer 320 may analyze waste movement, for example, such as onsite water treatment, solid waste management, liquid waste management, and the like. For the space utilization factor, the data analyzer 320 may compare the number of employees present at any given time with zone or space area details to determine if the zone or space is overcrowded, under-utilized, or within a desirable capacity.

Still referring to FIG. 3, the score calculator 328 calculates an effectiveness score for the retail enterprise (or for each node of the retail enterprise) based on the analyzed data. For example, in some embodiments, the effectiveness score for a retail enterprise is calculated based on sales data, energy consumption, equipment efficiency, operation and maintenance, occupant comfort, compliance, and space utilization. In some embodiments, score calculator 328 applies a weightage to each of the factors based on the preferences or goals of the retail enterprise, so that the factors are given proper weights when calculating the effectiveness score. In various embodiments, the weightage is defined by a user of the retail enterprise, or determined based on historical data. Accordingly, the weightage for each of the factors can vary depending on the goals or preferences of a particular retail enterprise. In a non-limiting example, score calculator 328 applies weightage to the example factors discussed above for a particular retail enterprise, so that 35 percent is assigned to the building energy performance factor, 20 percent is assigned to the equipment performance factor, 10 percent is assigned to occupant comfort, 10 percent is assigned to operation & maintenance, 5 percent is assigned to water usage, 5 percent is assigned to renewable energy, 5 percent is assigned to waste management, 5 percent is assigned to compliance, and 5 percent is assigned to space utilization. In this case, the factors that the particular retail enterprise identifies as being more important has a larger weight on the overall effectiveness score calculation. However, the present disclosure is not limited thereto, and while the effectiveness score generally considers more than one factor, an effectiveness score for only one factor can be calculated. In this case, the weightage assigned to the one factor is 100 percent of the overall effectiveness score.

In some embodiments, a factor may include various sub-factors that are weighted and scored as part of the weightage of the factor on the overall effectiveness score. In this case, the data analyzer 326 compares the actual value of each of the analyzed sub-factors with a benchmark value, and determines a deviation (or change) therebetween. In some embodiments, the benchmark value is dynamically adjusted according to historical data, and is tracked to determine the deviation. In some embodiments, the score calculator 328 assigns a maximum allowable score for each of the sub-factors based on the overall weightage of the factor. The score calculator 328 generates a score for each of the sub-factors based on the maximum allowable score and deviation from the benchmark value.

For example, if the deviation (or change) for a particular sub-factor indicates a vast improvement over a first threshold value (e.g., 25% positive change or more) with respect to the benchmark value, the score calculator 328 can calculate the score for the sub-factor as the maximum allowable score for the sub-factor. On the other hand, if the deviation for a particular sub-factor indicates a vast deterioration over a second threshold value (e.g., 25% negative change or more) with respect to the benchmark value, the score calculator 328 can calculate the score for the sub-factor to be at a minimum value (e.g., 0). Similarly, if the deviation for a particular sub-factor indicates some improvement or deterioration with respect to the benchmark value, but between the corresponding first and second threshold values, the score calculator 328 can calculate the score to be between the minimum and the maximum values for the particular sub-factor. However, the present disclosure is not limited thereto, and the score can be calculated by any suitable methods based on the change in values.

For example, in some embodiments, the building energy performance factor includes the sub-factors EUI, HVAC consumption, lighting consumption, and plug load. If the building energy performance factor has a weightage assigned at 35 percent, the score calculator 328 can assign a maximum allowable score for each of the sub-factors that has a combined weightage of 35. For example, the score calculator 328 can assign a maximum allowable score of 15 for the EUI sub-factor, a maximum allowable score of 10 for the HVAC consumption sub-factor, a maximum allowable score of 5 for the lighting consumption sub-factor, and a maximum allowable score of 5 for the plug load sub-factor, so that the total weightage (or maximum score) for the building energy performance factor is 35. In this case, the effectiveness score for the building energy performance factor is calculated based on the percentage of a change between the actual value and the benchmark value for each of the sub-factors, as shown in the non-limiting example of Table 2:

| Sub-Factor | Max Score | Benchmark Value | Actual Value | % Change | Score |
|---|---|---|---|---|---|
| EUI (kBtu/SF/Month) | 15 | 70 | 63 | 10% | 10.5 |
| HVAC (kWh) | 10 | 160,000 | 136,000 | 15% | 5 |
| Lighting (kWh) | 5 | 50,000 | 42,500 | 15% | 4 |
| Plug Load (kWh) | 5 | 400,000 | 480,000 | −20% | 0.5 |
| Total | 35 | | | | 20 |

In some embodiments, the score calculator 328 similarly scores the other factors and corresponding sub-factors, if any, based on their respective weightage and the analyzed data, and sums the total score for each of the factors to calculate the overall effectiveness score. In some embodiments, the enterprise platform 320 generates an effectiveness score for each node of the retail enterprise, and/or generates an effectiveness score (e.g., an average effectiveness score) for the retail enterprise as a whole.

In various embodiments, the effectiveness score is presented to a user of the retail enterprise on a graphical user interface (GUI) or dashboard. For example, still referring to FIG. 3, in some embodiments, BMS 300 includes several applications 330 including an energy management application 332, monitoring and reporting applications 334, and enterprise control applications 336. Although only a few applications 330 are shown, it is contemplated that applications 330 include any of a variety of suitable applications configured to use the data samples or data (e.g., effectiveness score) generated by enterprise platform 320. In some embodiments, applications 330 exist as a separate layer of BMS 300 (e.g., a part of enterprise platform 320 and/or data collector 312). In other embodiments, applications 330 exist as remote applications that run on remote systems or devices (e.g., remote systems and applications 244, client devices 248, and/or the like).

Applications 330 can use the data generated by the enterprise platform 320 to perform a variety of data visualization, monitoring, and/or control activities. For example, in some embodiments, energy management application 332 and monitoring and reporting application 334 use the data to generate user interfaces (e.g., charts, graphs, etc.) that present the effectiveness score to a user (e.g., a user associated with the retail enterprise). In some embodiments, the user interfaces present the raw data samples and the effectiveness score in a single chart or graph. For example, a dropdown selector can be provided to allow a user to select the raw data samples or any of the derived effectiveness scores as data rollups for a given data point.

In some embodiments, the user can select to view the overall effectiveness score (or average effectiveness score), or can select to view individual key performance indicators (e.g., factors and sub-factors) that make up the overall effectiveness score. In some embodiments, the user can view a report indicating the nodes with the highest effectiveness scores for each of the performance indicators, and the nodes with the lowest effectiveness score for each of the performance indicators. In some embodiments, the user can select a particular one of the nodes to view its effectiveness score and key performance indicators. In some embodiments, the user can select various ones of the nodes for viewing their respective effectiveness scores and key performance indicators, for comparison with each other or with the overall effectiveness score and key performance indicators of the retail enterprise. In some embodiments, the user can select the method in which the effectiveness score and/or performance indicators are presented (e.g., bar chart, line graph, pie graph, etc.). In some embodiments, the user can select a particular time (e.g., date and time) or a particular timeframe for which the effectiveness score and key performance indicators are shown. Accordingly, the user can quickly determine the performance indicators that can be improved for each of the nodes, and can effectively address those areas of improvement to enhance the operational efficiency of the retail enterprise.

In some embodiments, enterprise control application 336 uses the data to perform various control activities. For example, enterprise control application 336 can use the effectiveness score to generate inputs to a control algorithm (e.g., a state-based algorithm, an extremum seeking control (ESC) algorithm, a proportional-integral (PI) control algorithm, a proportional-integral-derivative (PID) control algorithm, a model predictive control (MPC) algorithm, a feedback control algorithm, etc.) to generate control signals for building subsystems 228. In some embodiments, building subsystems 228 uses the control signals to operate building equipment. Operating the building equipment affects the measured or calculated values of the data samples provided to BMS 300 and/or enterprise platform 320, which in turn are reflected in the effectiveness score. Accordingly, enterprise control application 336 uses the data as feedback to control the systems and devices of building subsystems 228 to perform controls that can enhance or improve various performance indicators considered in the effectiveness score.

Enterprise Platform with Facial Recognition

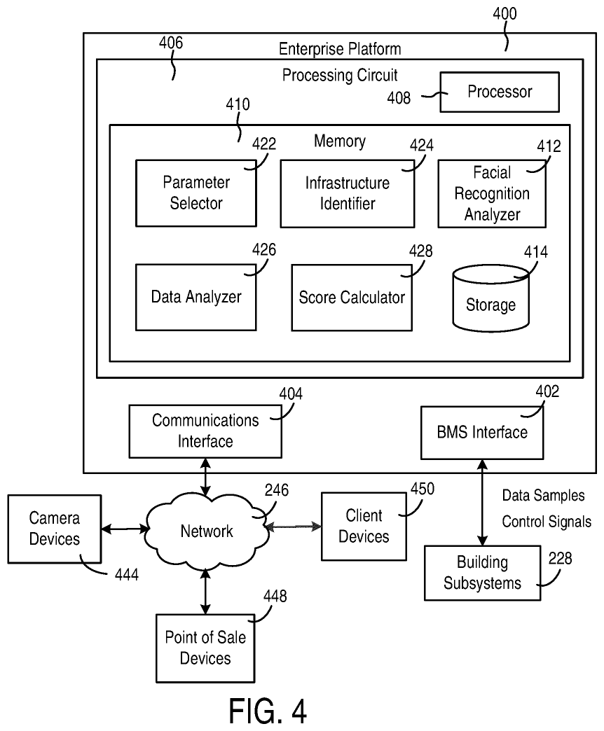

Referring now to FIG. 4, a block diagram illustrating another enterprise platform is shown, according to various embodiments. In various embodiments, enterprise platform 400 is similar to or the same as the enterprise platform 320 with reference to FIG. 3. However, the present disclosure is not limited thereto, and in other embodiments, enterprise platform 400 is implemented as a component of any of the BMS systems described above, or is implemented on one or more dedicated computers or servers. Further, in various embodiments, the components of enterprise platform 400 is integrated within a single device (e.g., a supervisory controller, a BMS controller, etc.) or distributed across multiple separate systems or devices. In other embodiments, some or all of the components of enterprise platform 400 is implemented as part of a cloud-based computing system configured to receive and process data from one or more BMSs, building sub-systems, and/or devices (e.g., camera devices, client devices, point of sales devices, and/or the like.

In other embodiments, some or all of the components of enterprise platform 400 are components of a subsystem level controller (e.g., a HVAC controller), a subplant controller, a device controller (e.g., AHU controller, a chiller controller, etc.), a field controller, a computer workstation, a client device, or any other system or device that receives and processes data from building systems, equipment, and devices.

In various embodiments, enterprise platform 400 analyzes facial data to assess the performance of the retail enterprise (or nodes of the retail enterprise). For example, in some embodiments, enterprise platform 400 receives facial data from various camera devices arranged at various locations, and analyzes the facial data to detect emotions, demographics, preferences, behaviors, and/or the like of customers or potential customers to provide actionable insights into the performance of the retail enterprise. For example, in some embodiments, enterprise platform 400 receives facial data from camera devices arranged to track customers' faces when entering the node, leaving the node, and/or purchasing goods or services from the node. In some embodiments, enterprise platform 400 receives facial data from camera devices arranged to track customers' faces as they view products. For example, the camera devices can be arranged above the products, on product packaging, on pricing information tags or displays, and/or the like. In some embodiments, enterprise platform 400 receives facial data from camera devices that track one or more persons viewing an advertisement board. In some embodiments, enterprise platform 400 correlates the facial data with data from other data sources to determine relationships between the data or the data sources. In some embodiments, enterprise platform 400 generates an effectiveness score for various performance indicators identified from analyzing the facial data. Several features of enterprise platform 400 are described in more detail below.

Still referring to FIG. 4, in some embodiments, enterprise platform 400 includes a communications interface 402 and a BMS interface 404. The BMS interface 402 can be the same as or similar to the BMS interface 302 and the communications interface 404 can be the same as or similar to the communications interface 304, as described with reference to FIG. 3. For example, in various embodiments, interfaces 402 and 404 include a wired or wireless communications interface (e.g., jacks, antennas, transmitters, receivers, transceivers, wire terminals, etc.) for conducting data communications with building subsystems 228, camera devices 444, point of sales devices 448, client devices 448, or other external systems or devices. In various embodiments, communications conducted via interfaces 402 and 404 are direct (e.g., local wired or wireless communications) or via a communications network 246 (e.g., a WAN, the Internet, a cellular network, etc.).

Communications interface 404 facilitates communications between enterprise platform 400 and one or more camera devices 444, point of sales devices 448, and client devices 450. In some embodiments, the camera devices 444 can be closed-circuit television (CCTV) cameras or internet protocol (IP) cameras. In some embodiments, the point of sales devices 448 can include camera devices to capture facial images of the customers. The camera devices 444 and the point of sales devices 448 sends facial data and/or sales data corresponding to the customers to the enterprise platform 400 via the communications interface 402. In some embodiments, BMS interface 404 facilitates communications between enterprise platform 400 and building subsystems 228 (e.g., directly or via BMS 300 as shown in FIG. 3). In some embodiments, enterprise platform 400 is configured to communicate (e.g., directly or via BMS 300) with building subsystems 228 using any of a variety of building automation systems protocols (e.g., BACnet, Modbus, ADX, etc.). In some embodiments, enterprise platform 400 receives data samples from building subsystems 228 and provides control signals to building subsystems 228 (e.g., directly or via BMS 300) via BMS interface 404.

BMS interface 402 facilitates communications between enterprise platform 400 and building subsystems 228 (e.g., directly or via BMS 300). In some embodiments, enterprise platform 400 is configured to communicate (e.g., directly or via BMS 300) with building subsystems 228 using any of a variety of building automation systems protocols (e.g., BACnet, Modbus, ADX, etc.). In some embodiments, enterprise platform 400 receives data samples from building subsystems 228 and provides control signals to building subsystems 228 via BMS interface 402. For example, in some embodiments, enterprise platform 400 receives data from various building subsystems 228 (e.g., via BMS 300), and sends control signals to the building subsystems 228. Enterprise platform 400 calculates an efficiency score based on the data to assess the performance of a retail enterprise, as discussed above.

Still referring to FIG. 4, in some embodiments, enterprise platform 400 includes one or more processing circuits 406 including one or more processors 408 and memory 410. Each of the processors 408 can be a general purpose or specific purpose processor, an application specific integrated circuit (ASIC), one or more field programmable gate arrays (FPGAs), a group of processing components, or other suitable processing components. Each of the processors 408 is configured to execute computer code or instructions stored in memory or received from other computer readable media (e.g., CDROM, network storage, a remote server, etc.).

Memory 410 can include one or more devices (e.g., memory units, memory devices, storage devices, etc.) for storing data and/or computer code for performing and/or facilitating the various processes described in the present disclosure. Memory 410 can include random access memory (RAM), read-only memory (ROM), hard drive storage, temporary storage, non-volatile memory, flash memory, optical memory, or any other suitable memory for storing software objects and/or computer instructions. Memory 410 can include database components, object code components, script components, or any other type of information structure for supporting the various activities and information structures described in the present disclosure. Memory 410 can be communicably connected to the processors 408 via the processing circuits 406 and can include computer code for executing (e.g., by processor 408) one or more processes described herein.

In some embodiments, memory 410 includes a parameter selector 422, an infrastructure identifier 424, a facial recognition analyzer 412, a data analyzer 426, a score calculator 428, and storage 414. While storage 414 is shown in FIG. 4 as being part of the memory 410, the present disclosure is not limited thereto, and in various embodiments, storage 414 can be internal storage or external storage. For example, storage 414 can be part of storage 314 in FIG. 3, internal storage with relation to enterprise platform 400, and/or can include a remote database, cloud-based data hosting, or other remote data storage. In some embodiments, the parameter selector 422 and the infrastructure identifier 424 is similar to or the same as the parameter selector 422 and the infrastructure identifier 424 as described with reference to FIG. 3, and thus, detailed descriptions thereof will not be repeated.

In various embodiments, facial recognition analyzer 412 receives facial data from various data sources (e.g., camera devices, point of sales devices, digital advertisement boards, and/or the like), and detects, identifies, and classifies the faces in the facial data for emotions, demographics, and/or the like. In some embodiments, facial recognition analyzer 412 analyzes complex facial data using a hybrid convolutional neural network having variable depths, which can reduce training time and computing power for analyzing the complex facial data. For example, in some embodiments, a sample dataset of images depicting a variety of emotions or demographics of human faces is fed to facial recognition analyzer 412, and the dataset is split into any suitable training, validation, and test set ratio (e.g., 29:4:4, respectively), to train the facial recognition analyzer 412 to classify the images into a variety of emotions, demographics, and/or the like. For example, emotions can be classified into 0=Angry, 1=Disgust, 2=Fear, 3=Happy, 4=Sad, 5=Surprise, 6=Neutral, and the like. However, the present disclosure is not limited thereto, and the facial data may be classified into any suitable number of emotions, demographics, and/or the like.

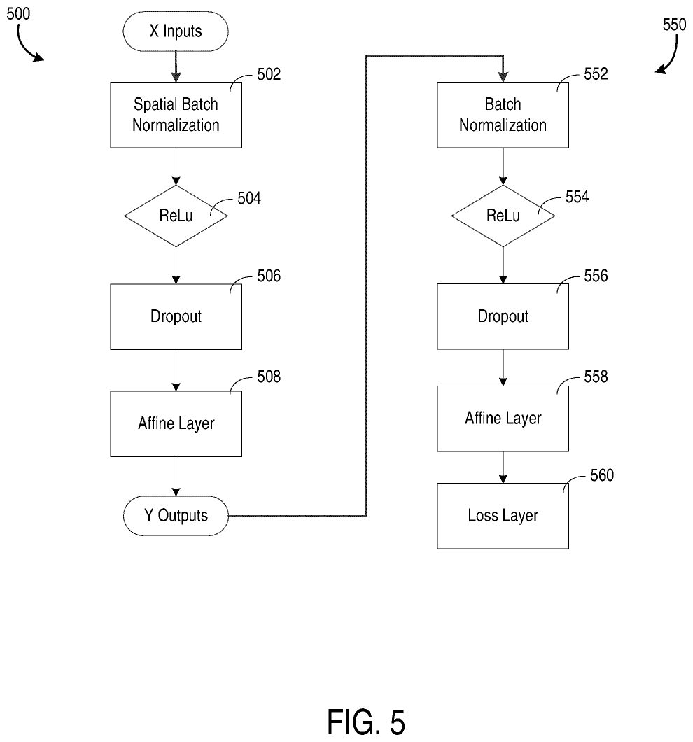

In various embodiments, the hybrid convolutional neural network includes a variable number of convolution layers and a set of fully connected layers. The facial recognition analyzer extracts facial features of the facial data in the convolution layers, and the output is fed through the fully connected layers for classifying the facial features. For example, referring to FIG. 5, the convolution layers 500 include a spatial batch normalization layer 502, a rectifier linear unit (ReLu) layer 504, a dropout layer 506, and an affine layer 508, and the fully connected layers 550 include a batch normalization layer 552, a ReLu layer 554, a dropout layer 556, an affine layer 558, and a loss layer 560. The x inputs represent facial data (e.g., facial image frames) that are received by the facial recognition analyzer 412 and input to the convolutional layers 500 to extract the facial features, and the Y outputs correspond to the features extracted by the convolution layers 500 that are input to the fully connected layers 550 for classification.

A convolution property may be defined as the values of weights assigned to all pixels of an image. A convolutional neural network gives equal weightage to all parts of the image. The spatial batch normalization layer 502 and batch normalization layer 552 normalizes the output of a previous activation layer for hidden layers of the convolution layers 500 and the fully connected layers 550, so that equal weightage is given to each part of the image. Batch normalization is applied to every dimension (x=Wu) with another pair of learned parameters (α^{k}β^{k}) per dimension. The output features per layer is W×H×C, wherein W corresponds to width, H corresponds to height, and C corresponds to the number of filters (or channels).

The ReLu layers 504 and 554 apply a special case ramp function that computes the non-saturating activation function f(x)=max(0, x). The ReLu layers 504 and 554 increase nonlinear properties of the network, and accelerates the convergence of stochastic gradient descent (SGD) over other functions, such as sigmoid and tan(x). The function of the ReLu layers 504 and 554 are also a less complicated computation than sigmoid and tan(x).

The dropout layers 506 and 556 reduce overfitting by reducing the network for training, and helps to increase generalization. At each training phase, individual nodes are dropped out with a probability of (1-p), so that a reduced network remains. The connected edges of the dropped out nodes are also removed. Thus, the reduced network is trained on the facial data for that training phase, and the dropped out nodes and corresponding connections are reintroduced post training.

In some embodiments, the convolution layers 500 and/or the fully connected layers 550 optionally include, in addition to, or in lieu of, the drop out layers 506 and 556, a global or local pooling layer. The pooling layer aggregates the outputs of neuron clusters in one layer as a single neuron input for the next layer. The pooling layer progressively reduces the spatial size of the facial data, reduces the number of parameters and amount of computation in the network, and can also help to control overfitting. In some embodiments, the pooling layer implements max pooling to select the maximum value from each of a cluster of neurons at the previous layer.

The affine layers 508 and 558 applies weights to the inputs by multiplying the input matrix by the weight matrix. The loss layer 560 is generally the last layer of the fully connected layers 550, and calculates the deviation between the predicted and actual values of the facial data using a loss function (e.g., Softmax). Accordingly, in various embodiments, the facial recognition analyzer 412 is trained using the hybrid convolutional neural network. In various embodiments, the facial recognition analyzer 412 analyzes and classifies facial data received from various camera devices for emotions, demographics, and/or the like.

Still referring to FIG. 4, while facial recognition analyzer 412 is shown as being separate from data analyzer 426, the present disclosure is not limited thereto, and in some embodiments, the facial recognition analyzer 412 is a part of the data analyzer 426. Data analyzer 426 analyzes the classified facial data to generate actionable insights based on the facial data, in some embodiments. In some embodiments, the data analyzer 426 is similar to or the same as the data analyzer 326 with reference to FIG. 3, and performs the same or similar functions as those of data analyzer 326. For example, in some embodiments, data analyzer 426 cleanses the facial data to eliminate or reduce unnecessary data (e.g., outliers), and identifies relationships between the facial data from different data sources (e.g., camera devices) and between the facial data and other data from other data sources (e.g., point of sales devices).

For example, in some embodiments, data analyzer 426 correlates the number of customers entering a node that appear to be happy, neutral, sad, angry, and/or the like, with the number of customers leaving the node that appear to be happy, neutral, sad, angry, and/or the like, to determine a change or deviation in the emotional state of the customers. The change or deviation is used to generate actionable insights into the performance of the node. For example, in some embodiments, the data analyzer 426 compares the number of customers that appear to enter the node happy or neutral with the number of customers that appear to leave the node happy or neutral to calculate the change or deviation to analyze customer satisfaction. In this case, in some embodiments, data analyzer 426 cleanses the facial data, for example, by eliminating data corresponding to customers that enter the node sad or angry and also leave the node sad or angry, since those customers may be sad or angry for external factors that are beyond the control of the node irrespective of customer satisfaction. Likewise, in some embodiments, data analyzer 426 eliminates data corresponding to groups of customers entering the store in an excited or overly happy state as those customers may be friends that are generally happy to shop together regardless of customer service. In some embodiments, data analyzer 426 calculates the net change or deviation in the emotions for the customers entering and leaving the node. In some embodiments, data analyzer 426 calculates the change or deviation for each individual customer entering and leaving the node on a one-to-one relationship.

In some embodiments, data analyzer 426 correlates the change or deviation of the emotions of customers entering and leaving the node with other data. For example, data analyzer 426 correlates the facial data with sales data or other relevant data to determine various performance indicators of the node. For example, based on low sales data and the facial data indicating that more customers appear to enter the store happy or neutral than leave the store happy or neutral, the data analyzer 426 can infer (or determine) that the node is improperly staffed, the service provided by employees of the node are unsatisfactory, or the like. In another example, enterprise platform 400 correlates facial data with time data to predict foot traffic (e.g., peak shopping hours and down shopping hours) for the node. In this case, the data is presented to the retail enterprise (e.g., via a dashboard), and the retail enterprise can utilize the data to staff more employees during the peak shopping hours and less employees during the down shopping hours. In another example, data analyzer 426 determines from the facial data that customers generally appear to be satisfied with the customer service of the node, and that foot traffic into the node appears to be at a desired level. However, from the sales data, data analyzer 426 can determine that sales numbers are too low based on the emotions of customers and the foot traffic level. In this case, data analyzer 426 can determine that the price point of the goods or services are too high. In this case, the retail enterprise can use this data to concentrate its efforts to boost the sale of goods or services, such as promotions or sales, instead of using resources on training employees or attracting more foot traffic into the node.

In some embodiments, data analyzer 426 analyzes the demographics or emotions from facial data received from camera devices that track customers' faces as they view products. For example, the camera devices can be arranged above the products, on product packaging, on pricing information tags or displays, and/or the like. In this case, the camera devices capture facial data of the customers as they view the products and decide whether or not to purchase the products. In some embodiments, data analyzer 426 determines the amount of time spent viewing the products, the parts of the product packaging that the customer spent more time viewing, the pricing of the product that customers finds acceptable, and/or the like. In this case, the retail enterprise can use this information to prioritize product stock, product arrangement, product pricing, and/or the like, such that more popular products are readily available, easily accessible, and appropriately priced.

In some embodiments, data analyzer 426 analyzes the demographics of the customers or potential customers, such as gender, age, race, and the like. For example, data analyzer 426 can determine from the demographics data that the node attracts more women than men, more adults between 30-40 years of age than teens and young adults between 16-25 years of age, or the like. In this case, the retail enterprise can use the demographics data to cater to its main customer base, for example, by stocking more goods desired by its main customer base, running sales or promotions targeting its main customer base, adjusting prices (lower or higher) on the goods or services desired by its main customer base, directing advertisements to its main customer base, staffing the node with employees having desired demographics by its main customer base, and/or the like. Similarly, the retail enterprise can use the demographics data to broaden its customer base by attracting customers with different demographics from its main customer base.

In some embodiments, data analyzer 426 analyzes the classified facial data from camera devices that track one or more persons viewing an advertisement board. In this case, data analyzer 426 analyzes the emotions, demographics, preferences, behaviors, and/or the like of the person from the facial data to assess the effectiveness of the advertisement, or provides suggestions for targeted advertisements on the advertisement board based on the demographics or emotions of the general population viewing the advertisement. In some embodiments, the data analyzer 426 analyzes the demographics or emotions of a person viewing a digital advertisement board in real-time (or substantially real-time), and the content of the digital advertisement board is dynamically changed based on the demographics or emotions of the person. For example, if data analyzer 426 determines that the person viewing the advertisement is a male in his late teens or early 20s, enterprise platform 400 can generate a control signal to cause display of an advertisement that is likely to interest the person, for example, such as an advertisement for a video game rather than an advertisement for a sewing machine.

Still referring to FIG. 4, the score calculator 428 calculates an effectiveness score for the retail enterprise (or for each node of the retail enterprise) based on the analyzed facial data. For example, some of the factors for the effectiveness score based on the facial data may include, customer satisfaction, foot traffic performance, staffing performance, advertisement effectiveness, product placement effectiveness, pricing performance, and/or the like. The score calculator 428 can be similar to or the same as the score calculator 328 as discussed with reference to FIG. 3, and thus, detailed description thereof will not be repeated. In some embodiments, as discussed above, enterprise platform 400 (e.g., via monitoring and reporting application 334) uses the analyzed facial data to generate user interfaces (e.g., charts, graphs, etc.) that present the effectiveness score to a user (e.g., a user associated with the retail enterprise).

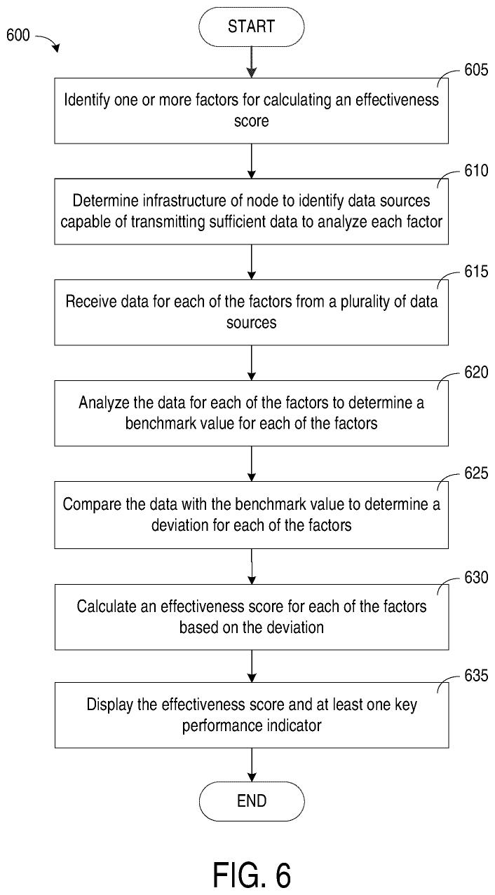

FIG. 6 is a flow diagram of a processor method for calculating an effectiveness score, according to an exemplary embodiment. According to the non-limiting example shown in FIG. 6, the process 600 starts and the parameter selector 322 or 422 identifies one or more factors for calculating the effectiveness score at block 605. The factors are selected depending on the priorities or goals of the retail enterprise. For example, some of the factors can include revenue, energy efficiency, equipment efficiency, waste management, regulatory compliance, economic benefits, stakeholder experience, risk management, customer insights, operational performance, environmental performance, safety and security, and/or the like.

The infrastructure identifier 324 or 424 analyzes the infrastructure of each node at block 610 to determine if each node is able to produce the desired data sufficient to analyze each of the factors. In some embodiments, infrastructure identifier 324 or 424 analyzes the infrastructure] by comparing received data from each node with the expected desired data to determine if some data is missing. If a node does not produce the missing data, infrastructure identifier 324 or 424 provides a recommendation via a display device to configure one or more additional data sources to generate the missing data for the node, in some embodiments.

Data is received from a plurality of data sources to analyze each of the factors at block 615. In some embodiments, data analyzer 326 or 426 cleanses the data to eliminate or reduce unnecessary data, and identifies the relationships between the data or the data sources to organize/format the data to be analyzed for its respective factor. Thus, instead of using data from different data source in isolation, data analyzer 326 or 426 amalgamates the data at an enterprise level to determine its effect on the priorities or goals of the enterprise. Accordingly, the user is presented (e.g., on a graphical user interface) the actual aggregate impact of the data from various data sources on particular factors (or key performance indicators), rather than being presented several isolated data points in a generic index. In some embodiments, the data sources can include, for example, a sales data repository, enterprise resource planning repository, equipment maintenance repository, regulatory compliance repository, suitable sensor (e.g., temperature sensor, CO2 sensor, occupancy sensor, image sensor, or the like), suitable device (e.g., camera devices, point of sales devices, or the like), and/or any other suitable repository, sensor, or device.

The data analyzer 326 or 426 analyzes the data to determine a benchmark value for each of the factors at block 620, and the data is compared with the benchmark value to determine a deviation (or change) between the actual value of the data and the benchmark value at block 625. In some embodiments, a weightage is calculated for each of the factors corresponding to the priorities or goals of the retail enterprise. In some embodiments, at least one of the factors includes a plurality of sub-factors. In this case, a maximum score for each of the sub-factors is calculated, where a total sum of the maximum scores for the sub-factors correspond to the weightage of the factor. For example, if the weightage of the factor is 25 percent, the total sum of the maximum scores for the sub-factors of the factor is 25. In some embodiments, the data analyzer 326 or 426 calculates a benchmark value for each of the sub-factors, and compares the actual value of the sub-factors with the benchmark values to determine a deviation or change therebetween. The score calculator 328 or 428 calculates an effectiveness score for each of the factors (and sub-factors) based on the deviation at block 630.

The effectiveness score and at least one key performance indicator (e.g., factor) is displayed on a display device at block 635, and the process may end. In some embodiments, the effectiveness score is presented on a graphical user interface (GUI) or dashboard on the display device. In some embodiments, the user can select to view the overall effectiveness score (or average effectiveness score), or can select to view individual key performance indicators (e.g., factors and sub-factors) that make up the overall effectiveness score. In some embodiments, a user can select a node to view a detailed overview of the performance indicators for the selected node. In some embodiments, the user can select another node for comparison of the key performance indicators of the nodes. In some embodiments, the user can view a report indicating the nodes with the highest effectiveness scores for each of the performance indicators, and the nodes with the lowest effectiveness score for each of the performance indicators. In some embodiments, the user can select a particular one of the nodes to view its effectiveness score and key performance indicators. In some embodiments, the user can select various ones of the nodes for viewing their respective effectiveness scores and key performance indicators, for comparison with each other or with the overall effectiveness score and key performance indicators of the retail enterprise. In some embodiments, the user can select the method in which the effectiveness score and/or performance indicators are presented (e.g., bar chart, line graph, pie graph, etc.). In some embodiments, the user can select a particular time (e.g., date and time) or a particular timeframe for which the effectiveness score and key performance indicators are shown.

Accordingly, in various embodiments, the user is presented (e.g., on a graphical user interface or interactive dashboard) the effect of the data from various data sources on the performance indicators for each node and for the retail enterprise as a whole in the effectiveness index, rather than being presented several isolated data points in a generic index. Further, the user can quickly identify and compare the top performing nodes with the bottom performing nodes to quickly identify the performance areas that can be improved, rather than having to scroll through a generic index to identify data points and performers. For example, the use can simply select to nodes to compare the performance indicators for those two nodes instead of having to identify the nodes and data points by scrolling through a generic index. Accordingly, various embodiments of the present invention improves a computer by correlating data from various data points and displaying the data in a meaningful and resourceful manner.

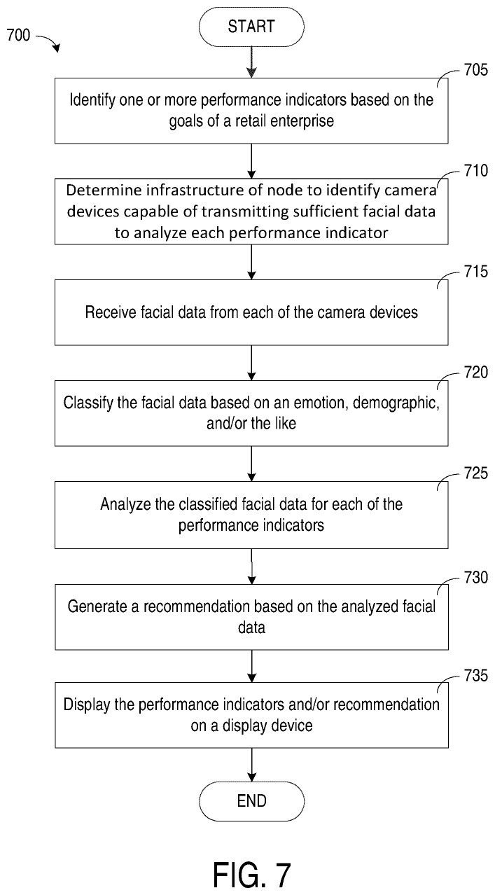

FIG. 7 is a flow diagram of a processor method for generating actionable insights based on facial data, according to an exemplary embodiment. According to the non-limiting example shown in FIG. 7, the flow 700 starts and the parameter selector 322 or 422 identifies one or more performance indicators (or factors) based on the priorities or goals of the retail enterprise at block 705. For example, some of the performance indicators can include customer satisfaction, foot traffic performance, staffing performance, advertisement effectiveness, product placement effectiveness, product pricing, and/or the like.

The infrastructure identifier 324 or 424 analyzes the infrastructure of each node at block 710 to determine if each node is able to produce the desired facial data sufficient to analyze each of the performance indicators. In some embodiments, the infrastructure identifier 324 or 424 analyzes the infrastructure to determine if one or more camera devices are arranged to transmit facial data of customers entering a node, leaving a node, purchasing products, viewing products, viewing advertisement boards, and/or the like. If a node does not have sufficient camera devices configured to transmit the facial data, the infrastructure identifier 324 or 424 provides a recommendation via a display device to configure one or more additional camera devices to generate the desired facial data for the node, in some embodiments.

Facial data is received from each of the camera devices at block 715, and the facial recognition analyzer 412 classifies the facial data based on an emotion, demographic, and/or the like of the customers corresponding to the facial data. In some embodiments, the facial recognition analyzer 412 analyzes the facial data using facial recognition techniques that implement a hybrid convolutional neural network. In some embodiments, the data analyzer 326 or 426 cleanses the facial data to eliminate or reduce unnecessary data, and identifies relationships between the facial data or the camera devices to organize/format the data to be analyzed for its respective performance indicator. For example, in some embodiments, the data analyzer 326 or 426 compares a number of customers exhibiting a first emotion (e.g., happy, neutral, sad, angry, or the like) from among the customers entering the store with a number of customers exhibiting the first motion from among the customer leaving the store to determine if there is a change in emotions. In some embodiments, facial data of customers viewing products is received, and the data analyzer 326 or 426 similarly determines a change in emotion of the customer viewing the product from the facial data. In these case, the data analyzer 326 or 426 analyzes one or more performance indicators based on the change in emotions.

In some embodiments, the data analyzer 326 or 426 correlates the facial data with other data, such as sales data, for example, to analyze one or more of the performance indicators. For example, in some embodiments, the sales data is received from a data source (e.g., a point of sales device) located in a node, and the data analyzer 326 or 426 correlates the sales data with the change in emotions data to determine if the change in emotions of the customers corresponds to more or less sales. In some embodiments, facial data is received from one or more viewers of an advertisement board, and the data analyzer 426 may analyze the demographics of the facial data to determine whether the content of the advertisement is targeted to the main audience of the advertisement board based on the demographics. In some embodiments, facial recognition analyzer 412 determines a viewer's demographic in real-time from the facial data, and the enterprise platform 400 changes the content of a digital advertisement board in real-time based on the demographic.

In some embodiments, a recommendation is generated based on the facial data at block 730. For example, in some embodiments, the data analyzer 326 or 426 analyzes the facial data to determine peak shopping times and/or down shopping times, and generates a recommendation for staffing the node based on the peak shopping times and/or down shopping times. In another example, the data analyzer 326 or 426 analyzes the facial data of a customer viewing products, and generates a recommendation of product placement, product stocking, and/or product pricing. The recommendation and/or performance indicators may be displayed on a display device at block 735, and the process may end.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, byway of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

The present disclosure may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, features or aspects within each example embodiment should typically be considered as available for other similar features or aspects in other example embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A building management enterprise system comprising:
a display device;
one or more processors; and
one or more computer-readable storage media communicably coupled to the one or more processors having instructions stored thereon that, when executed by the one or more processors, cause the one or more processors to:
identify one or more factors for evaluating economic effectiveness of an enterprise comprising a plurality of physical nodes;
receive data associated with each of the factors from a plurality of data sources for each of the nodes, the plurality of data sources including at least one sensor located in each of the nodes;
determine a benchmark value for each of the factors;
compare the data received from the plurality of data sources with the benchmark value for each of the factors;
calculate an effectiveness score for each of the factors based on the compare; and
control the display device to display one or more performance indicators associated with the effectiveness score for each of the nodes.

2. The system of claim 1, wherein the one or more factors include revenue, energy efficiency, equipment efficiency, waste management, and regulatory compliance.

3. The system of claim 1, wherein the plurality of data sources further include at least one sales data repository, enterprise resource planning repository, equipment maintenance repository or regulatory compliance repository.

4. The system of claim 1, wherein the instructions further cause the one or more processors to calculate a weightage for each of the one or more factors based on one or more priorities of the enterprise.

5. The system of claim 4, wherein each of the one or more factors contribute to the effectiveness score based on the weightage for each of the one or more factors.

6. The system of claim 5; wherein each of the one or more factors include a plurality of sub-factors.

7. The system of claim 6, wherein the instructions further cause the one or more processors to determine a maximum score for each of the sub-factors, wherein a total sum of the maximum scores for the sub-factors correspond to the weightage of the factor.

8. The system of claim 1, wherein the instructions further cause the one or more processors to:
identify desired data for evaluating each of the one or more factors;
compare the received data with the desired data to determine missing data; and
control the display device to display a recommendation to configure one or more additional data sources to generate at least some of the missing data.

9. The system of claim 1, wherein the performance indicators are presented on an interactive dashboard, and the instructions further cause the one or more processors to:
receive a selection of a node from among the plurality of nodes; and
control the display device to display a detailed overview of the performance indicators for the selected nodes.

10. The system of claim 9, wherein the instructions further cause the one or more processors to:
receive a selection of another node for comparing the performance indicators of the selected nodes; and
control the display device to display a comparison of the performance indicators for the selected nodes.

11. A building management enterprise system comprising:
one or more camera devices;
a display device;
one or more processors; and
one or more computer-readable storage media communicably coupled to the one or more processors having instructions stored thereon that, when executed by the one or more processors, cause the one or more processors to:
receive facial data from the one or more camera devices;
classify the facial data based on an emotion or demographic associated with an image in the facial data;
analyze the classified facial data to identify one or more performance indicators for a physical node of an enterprise; and
control the display device to display the one or more performance indicators for the node.

12. The system of claim 11, wherein the one or more performance indicators include at least one of customer satisfaction, foot traffic performance, staffing performance, advertisement effectiveness, product placement effectiveness, or product pricing performance.

13. The system of claim 11, wherein a first camera device from among the one or more camera devices is arranged to capture entering customers when entering the node, and a second camera device from among the one or more camera devices is arranged to capture leaving customers when leaving the node.

14. The system of claim 13, wherein the instructions further cause the one or more processors to:
receive facial data from the first camera device corresponding to the entering customers;
count a number of customers from among the entering customers exhibiting a first emotion from the facial data received from the first camera device;
receive facial data from the second camera device corresponding to the leaving customers;
count a number of customers from among the leaving customers exhibiting the first emotion from the facial data received from the second camera;
determine a change of emotions between the number of entering customers exhibiting the first emotion and the number of leaving customers exhibiting the first emotion; and
analyze the one or more performance indicators based on the change of emotions.

15. The system of claim 14, wherein the instructions further cause the one or more processors to:
receive sales data from a data source associated with the node;
associate the sales data with the change of emotions; and
analyze the one or more performance indicators based on the sales data and the change of emotions.

16. The system of claim 11, wherein the instructions further cause the one or more processors to:
calculate a peak shopping time from the facial data;
generate a recommendation for staffing the node based on the peak shopping time; and
control the display device to display the recommendation.

17. The system of claim 11, wherein a camera device from among the one or more camera devices is arranged to capture a customer's face while viewing a product, and the instructions further cause the one or more processors to:
determine a change in emotion of the customer while viewing the product based on the facial data; and
analyze the one or more performance indicators based on the change in emotion.

18. The system of claim 11, wherein a camera device from among the one or more camera devices is arranged to capture viewers of an advertisement board.

19. The system of claim 18, wherein the instructions further cause the one or more processors to:
track the demographics of the viewers viewing the advertisement board based on the facial data over a period of time;
generate a report of the demographics for the period of time; and
control the display device to display the report.

20. The system of claim 18, wherein the advertisement board is a digital advertisement board, and the instructions further cause the one or more processors to:
determine a demographic of a current viewer from among the viewers of the advertisement board from the facial data;
select content to be displayed on the digital advertisement board based on the demographic of the current viewer; and
control the digital advertisement board to display the content.
